(19) United States
(12) Patent Application Publication
(10) Pub. No.: US 2026/0257195 A1
(43) Pub. Date: Sep. 3, 2026

(54) Pet Litter Containing Tableted Clay

(71) Applicant: Boxiecat LLC, Santa Monica, CA (US)

(72) Inventors: Alvin Kershman, St. Louis, MO (US); Jeff Shear, Bonita Springs, FL (US); Harold Cole, St. Louis, MO (US); William Lewis, Pacific, MO (US)

(73) Assignee: Boxiecat LLC, Santa Monica, CA (US)

(21) Appl. No.: 19/552,770

(22) Filed: Feb. 27, 2026

Related U.S. Application Data
(60) Provisional application No. 63/765,580, filed on Mar. 1, 2025.

(51) Int. Cl. B01J 20/12; A01K 1/015; B01J 20/26; B01J 20/28

(52) U.S. Cl. CPC B01J 20/12; A01K 1/0154; A01K 1/0155; B01J 20/261; B01J 20/2803

(57) ABSTRACT

A cat litter comprising an absorbent material and at least one tableted clay containing from 50.0 to 99.9 wt. % clay, from 0.1 to 10 wt. % lubricant, from 0 to 10 wt. % disintegrating agent, from 0 to 10.0 wt. % super absorbent polymer, and from 0 to 10 wt. % beneficial additive, wherein the beneficial additive can be a probiotic. The cat litter absorbent material can be granulated sodium bentonite.

### CROSS-REFERENCE TO RELATED APPLICATIONS

This utility patent application claims the benefit of Provisional Patent Application 63/765,580 filed Mar. 1, 2025, which is hereby incorporated by reference.

### STATEMENT REGARDING FEDERALLY SPONSORED RESEARCH

Not Applicable.

### APPENDIX

Not Applicable.

### BACKGROUND OF THE INVENTION

### Field of the Invention

The present disclosure relates generally to pet litter compositions containing tableted clay, and methods that make tableted clay absorbent and suitable for the cat litter.

### Related Art

Litter boxes are used by cats for elimination of urine and fecal matter. A litter box contains a layer of cat litter that receives the urine and fecal matter. Typically the cat litter is granular and absorbent to facilitate formation of clumps after the urine and fecal matter is deposited in the cat litter. The clumps are typically sifted from the litter box using a litter scoop and then discarded.

It is known to add various additives such as probiotics, indicators, fragrances, etc. to cat litter to reduce the urine and fecal odor and provide other benefits. There are several ways known in the art to incorporate these additives in cat litter. The powdered additives can simply be sprinkled on top of the cat litter. Alternatively, the additives can be coated onto the cat litter which is subsequently granulated. There are numerous reasons that these approaches are ineffective, which include particle segregation and loss of coating due to particle deterioration caused by jostling and crushing when shipping.

The present invention provides a stable, tableted form of clay suitable for cat litter. It is desirable that the tableted clay be absorbent and that it form clumps with the non-tableted absorbent materials when wetted. In a preferred embodiment, beneficial additives which give desirable properties can be incorporated into the tablets.

### SUMMARY OF THE INVENTION

The present invention is an improved cat litter which comprises an absorbent material and tableted clay wherein the tableted clay consists of from 50.0 to 99.9 wt. % clay, from 0.1 to 10 wt. % lubricant, from 0 to 10 wt. % disintegrating agent, from 0 to 10.0 wt. % super absorbent polymer, and from 0 to 10 wt. % beneficial additive. In a preferred embodiment, the beneficial additive is at least one probiotic in the range of 0.1 to 5.0 wt. % of the tablet. The clay tablets are liquid absorbent. The clay tablets are preferably formed by compression tableting.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE PREFERRED EMBODIMENTS

The following description of the preferred embodiment(s) is merely exemplary in nature and is in no way intended to limit the invention, its application, or uses.

The claimed pet litter comprises at least one absorbent material and at least one clay tablet. The absorbent material can be any water-absorbent material or combination of absorbent materials commonly used in litters. Typically, the absorbent material is a dry, granular material. Preferably, said absorbent material is selected from the group consisting of clays, silica gels, woods (such as pine, aspen, cedar, fir, spruce), agricultural products, and combinations thereof. More preferably, said absorbent material is selected from the group consisting of clays, silica gels, pumice, absorbent foamed materials, and combinations thereof. In a particular embodiment, the absorbent material is clay, such as calcium or sodium montmorillonite (including sodium bentonite and calcium bentonite), smectite, ventriculite, attapulgite, opal clay and/or kaolin. The absorbent material, in particular clays, can be clumping and/or non-clumping. In a quick absorption test, the preferred absorbent material absorbs 10 wt. % or more of its weight with water after being submerged in water for one second.

Preferably, the tableted clay is not formulated with a binder such as lactose, corn starch, or a cellulosic polymer, for example, hydroxypropylmethylcellulose (HPMC), hydroxypropylcellulose (HPC), hydroxyethylcellulose, methylcellulose and/or ethylcellulose. The binder can cause difficulty in filling and emptying the die, as it often does not release the tablet completely. In the event that a binder is used in the tableted clay, preferably 5.0 wt. % or less is used. In a preferred embodiment, the binder is present in the tableted clay tablet from about 0 to 1 wt. %.

The tableted clay is made with a clay, in the amount of about 50 to 99.9 wt. % of the tablet. More preferably, the clay is present in the amount of 70 to 95 wt. %. Most preferably, the clay is present in the amount of 85 to 99.0 wt. %. The clay material is selected from the group that includes calcium or sodium montmorillonite (including sodium bentonite and calcium bentonite), smectite, ventriculite, attapulgite, opal clay and/or kaolin. The clays can be clumping and/or non-clumping, but clumping clays are preferred. The most preferred clay is sodium bentonite. In a quick absorption test, the preferred clay absorbs at least 10 wt. % of its weight with water after being submerged in water for about one second. A more preferred clay absorbs from 15 to 20 wt. % or more of its weight in water after being submerged in water for about one second.

Lubricants are commonly added to help in the tableting of many formulations. Following compression, a tablet must be ejected out of the tablet press die. Lubricants reduce the friction between the tablet and the die metal surface, which reduces the ejection force and helps to ensure that the tablet is cleanly ejected without cracking or breakage. Lubricant particles can form a boundary layer on the formulation particles or metal die surfaces. There are six types of commonly used boundary lubricants for tableting: (a) metallic salts of fatty acids such as sodium stearate; (b) fatty acids, hydrocarbons, and fatty alcohols such as hydrogenated fatty acids, such as Sterotex HM; (c) fatty acid esters; (d) alkyl sulfates; (e) polymers; and (f) inorganic materials such as fumed silica. Preferably, from about 0.1 to 20.0 wt. % of the tableted clay is a lubricant. More preferably, the lubricant is from about 0.1 to 15.0 wt. % of the tableted clay. Most preferably, the lubricant is from about 0.1 to 10.0 wt. % of the tableted clay.

A disintegrating agent, or a disintegrant is an additive that promotes disintegration, which is the breakage of a tablet into small fragments when in contact with a liquid. In doing so, the surface area available for interaction with a liquid is increased and the activation of the beneficial additive is initiated. Starches, and cellulose-based excipients are used as disintegrants. For example, croscarmellose sodium is a cross-linked sodium carboxymethyl cellulose disintegrant. Natural gums, such as guar gum, xanthan gum, and locust bean gum, are disintegrants that are obtained from plant sources. Ion exchange resins, such as polacrilin potassium and Amberlite IRP69, are synthetic polymers that contain functional groups that can exchange ions. Calcium silicates, such as dicalcium phosphate and tricalcium phosphate, are inorganic compounds that are commonly used as disintegrants. Sodium alginate is a natural polysaccharide obtained from brown algae that has been modified with sodium ions. Cross-linked polyvinylpyrrolidone is a synthetic polymer that has been cross-linked to increase its functionality, while chitosan is a natural polymer derived from chitin. Disintegrants are preferably used in the tableted clay in the amount of from 0 to 15.0 wt. %. More preferably, the amount of disintegrant in the tableted clay is from about 0 to 5 wt. %.

“Superabsorbent polymer” or “superabsorbent material” or “SAP” refers to a water-swellable, water-insoluble organic or inorganic material capable, under the most favorable conditions, of absorbing at least about 15 times its weight and, more desirably, at least about 30 times its weight in an aqueous solution containing 0.9 weight percent sodium chloride. The SAP materials can be natural, synthetic and modified natural polymers and materials. In addition, the SAP materials can be inorganic materials, such as silica gels, or organic compounds such as cross-linked polymers.

Sodium polyacrylate is a sodium salt of polyacrylic acid with the chemical formula [—CH₂—CH(CO₂Na)—]ₙ. This super-absorbent polymer (SAP) has the ability to absorb 100 to 1000 times its mass in water. Sodium polyacrylate is an anionic polyelectrolyte with negatively charged carboxylic groups in the main chain. When dissolved in water, it forms a thick and transparent solution due to the ionic interactions of the molecules. Sodium polyacrylate has many favorable mechanical properties. Some of these advantages include good mechanical stability, high heat resistance, and strong hydration. While sodium neutralized polyacrylic acids are the most common form used in industry, there are also other salts available including potassium, lithium and ammonium, which are included in the present invention.

Additional excipients, such as gel-forming agents, are contemplated for this invention. Carbopol 971P, a cross-linked polyanionic carbomer, is a polymer commonly used in tablet formulations, as it forms a gel-like matrix once the tablet comes into contact with water. When cat urine comes into contact with the clay tablet, a gel is formed that facilitates clumping in the cat litter.

The beneficial additives can include fragrances, color indicators, pheromones, probiotics, and others. The probiotic beneficial additive which reduces odor can be selected from a wide variety of bacteria and mixtures of bacteria. A number of urease negative organisms are known and are suitable for use as a probiotic in a litter product. Among them are strains selected from group N streptococcus, such as Lactococcus lactis; group D streptococcus, such as streptococcus faecium; Pediococcus such as Pediococcus acidilactici, Pediococcus cerevisiae, and Pediococcus pentosaeceus; propionibacterium such as propionibacterium shermanii and propionibacterium freudenreichii; leuconostoc; and Lactobacillus such as Lactobacillus acidophilus and Lactobacillus bulgaricus. Other nonspecific bacillus type organisms of compost and soil origin also are candidates. The probiotics comprise any one or combination of at least two of Bifidobacterium animalis, Lactobacillus or Enterococcus faecalis. Other probiotics are contemplated in the present invention. A preferred amount of probiotic bacteria in the tableted material is from about 0.01 to 25 wt. %. A more preferred amount of probiotic bacteria is from 0.01 to 5.0 wt. %.

The most common method for tableting is direct compression tableting, where dry components are inserted into the tablet die and compressed. A preferred shape of tablet is a polyhedron shape such as a cube or a cuboid, also called a rectangular prism.

In order for the tablets to function as a deodorant, it is necessary that the presence of the probiotics be physically near the spot where the cat urinates. The probiotic tablets must be uniformly disbursed in the cat litter, and the particle size must fall within the average particle size for the cat litter itself. In a preferred embodiment, the particle size of the cat litter ranges between a 12 and a 30 mesh screen size.

Tableted clay particles were made of the following compositions.

TABLE 1
Examples 1 to 10 - all values in weight %

| Components | Ex 1 | Ex 2 | Ex 3 | Ex 4 | Ex 5 | Ex 6 | Ex 7 | Ex 8 | Ex 9 | Ex 10 |
|---|---|---|---|---|---|---|---|---|---|---|
| Sodium | 90.0 | 89.8 | 89.5 | 89.0 | 88.5 | 88.0 | 87.5 | 87.0 | 86.0 | 85.0 |
| Bentonite | | | | | | | | | | |
| (clay) | | | | | | | | | | |
| Sterotex | 10.0 | 10.0 | 10.0 | 10.0 | 10.0 | 10.0 | 10.0 | 10.0 | 10.0 | 10.0 |
| HM | | | | | | | | | | |
| (Lubricant) | | | | | | | | | | |
| Sodium | — | 0.25 | 0.50 | 1.00 | 1.50 | 2.00 | 2.5 | 3.0 | 4.0 | 5.0 |
| Polyacrylate | | | | | | | | | | |
| (SAP) | | | | | | | | | | |
| Water | 12.2 | 17.2 | 17.7 | 16.6 | 16.7 | 17.5 | 19.0 | 15.6 | 16.4 | 16.1 |
| Absorption | | | | | | | | | | |

The sodium bentonite is BigHorn 40, which was sodium bentonite clay that passed through a 40 mesh screen. The Sterotex HM is a tableting lubricating agent made from hydrogenated soy bean oil sold by Abitex Corp. The sodium polyacrylate (SAP) was ground and passed through a 200 mesh screen.

The dry components were blended and then compression tableted. Most tablets were cuboid shaped.

The water absorption test was measuring the weight of the tablets in a mesh basket and immersing the basket in room temperature water for about 1 second. The longer times of 2 seconds or 5 seconds was used in Examples 15, 16, 22, 25-29, and 35, as indicated. The short amount of time allowed for absorption was chosen to simulate a cat urinating on the litter and rapidly activating the beneficial additive such as probiotics. The basket was removed and allowed to drip for 5 seconds. The absorbed water of the wetted tablets was determined.

The addition of SAP increased the absorptivity of the tableted clay.

TABLE 2
Examples 11 to 18, Control 1

| Components | Ex 11 | Ex 12 | Ex 13 | Ex 14 | Ex 15 | Ex 16 | Ex 17 | Ex 18 | Control 1 |
|---|---|---|---|---|---|---|---|---|---|
| Sodium | 96.0 | 97.0 | 98.0 | 96.0 | 96.5 | 91.5 | 93.5 | 95.82 | 100.0 |
| Bentonite | | | | | | | | | (Boxiecat ® |
| (clay) | | | | | | | | | litter) |
| Sterotex HM | 3.0 | 2.0 | — | — | — | — | 10.0 | — | — |
| (Lubricant) | | | | | | | | | |
| Magnesium | — | — | 1.00 | 1.0 | — | — | — | 1.00 | — |
| Stearate | | | | | | | | | |
| Lubricant | | | | | | | | | |
| Aerosil | — | — | — | — | 0.50 | 0.50 | 0.50 | — | — |
| 300(Lubricant) | | | | | | | | | |
| Explotab | — | — | — | — | — | 5.0 | — | — | — |
| (Disintegrant) | | | | | | | | | |
| Sodium | 1.0 | 1.0 | 1.0 | 3.00 | 3.00 | 3.00 | 6.0 | 3.0 | — |
| Polyacrylate | | | | | | | | | |
| (SAP) | | | | | | | | | |
| Pylaklor | — | — | — | — | — | — | — | 0.18 | — |
| White S-15A | | | | | | | | | |
| optical | | | | | | | | | |
| brightener | | | | | | | | | |
| Water | 12.7 | 13.3 | 17.7 | 16.6 | 19.4/22.2* | 13.9/14.2* | 42.1 | — | 68.6/79.8 |
| Absorption | | | | | | | | | |

*The 2 second absorption test.

The same tableting procedure was used as for Table 1.

Pylaklor White S-15A is made by Pylam Dyes, and contains 4-(2H-Naphtho[1,2-d]triazol-2-yl)-2-stilbenesulfonic Acid Sodium Salt. EXPLOTAB® disintegrant is Sodium Starch Glycolate which is sold by JRS Pharma. AEROSIL® 300 is a hydrophilic fumed silica with a high specific surface area of 300 m²/g and is sold by Evonik.

For Examples 18, 19 and 20, 0.20 g tablets were made with 2000 pound compression. For Control 1, sodium bentonite cat litter from Boxiecat®, granulated, was tested.

TABLE 3
Examples 19 through 29

| Components | Ex 19 | Ex 20 | Ex 21 | Ex 22 | Ex 23 | Ex 24 | Ex 25 | Ex 26 | Ex 27 | Ex 28 | Ex 29 |
|---|---|---|---|---|---|---|---|---|---|---|---|
| Sodium | 94.64 | 95.46 | 95.50 | 92.50 | 98.50 | 95.5 | 98.00 | 95.00 | 95.00 | 97.00 | 94.00 |
| Bentonite | | | | | | | | | | | |
| (clay) | | | | | | | | | | | |
| Magnesium | 1.00 | 1.00 | — | | — | — | — | 1.00 | 1.00 | — | — |
| Stearate | | | | | | | | | | | |
| Lubricant | | | | | | | | | | | |
| Aerosil | — | — | 0.50 | 0.50 | 0.50 | 0.50 | 0.50 | — | — | — | — |
| 300(Lubricant) | | | | | | | | | | | |
| Sodium | 3.0 | 3.0 | 3.0 | 6.00 | — | 3.00 | 6.0 | 3.0 | 3.0 | — | 3.00 |
| Polyacrylate | | | | | | | | | | | |
| (SAP) | | | | | | | | | | | |
| Probiotic | 0.10 | 0.10 | 0.10 | 0.10 | 0.10 | 0.10 | 0.10 | 0.10 | 0.10 | 0.10 | 0.10 |
| Lactose | 0.90 | 0.90 | 0.90 | 0.90 | 0.90 | 0.90 | 0.90 | 0.90 | 0.90 | 0.90 | 0.90 |
| Pylaklor | 0.36 | 0.54 | — | — | — | — | — | — | — | — | — |
| White | | | | | | | | | | | |
| S-15A | | | | | | | | | | | |
| optical | | | | | | | | | | | |
| brightener | | | | | | | | | | | |
| Pluronic F- | — | — | — | — | — | — | — | — | — | 2.00 | 2.00 |
| 127 | | | | | | | | | | | |
| Lubricant | | | | | | | | | | | |
| Water | — | — | — | 30.0/38.9* | 19.0 | 20.0 | 14.2/20.5* | 23.9/26.5* | 18.2/23.8* | 20.7/25.2* | 23.1/28.0* |
| Absorption | | | | | | | | | | | |

*The 5 second absorption test.

For Example 21, BigHorn 21 (particles that went through a 21 mesh sieve) replaced BigHorn 40 for the sodium bentonite clay. For Examples 22, 23 and 24, BigHorn 30 (particles that went through a 30 mesh sieve) replaced BigHorn 40 for the sodium bentonite clay. The probiotic and lactose mixture (BCC Cultuur from Nobel Bio) used in Examples 19 through 45 was 10 wt. % probiotic bacteria and 90 wt. % crystalline lactose, and are indicated as such in Tables 3, 4 and 5.

TABLE 4
Examples 30 to 36

| Components | Ex 30 | Ex 31 | Ex 32 | Ex 33 | Ex 34 | Ex 35 | Ex 36 |
|---|---|---|---|---|---|---|---|
| Sodium | 92.0 | 87.0 | 82.0 | 78.0 | 94.0 | 94.0* | 94.00 |
| Bentonite | | | | | | | |
| (clay) | | | | | | | |
| Sodium | 2.0 | 2.0 | 2.0 | 2.00 | 3.0 | 3.00 | 3.0 |
| Polyacrylate | | | | | | | |
| (SAP) | | | | | | | |
| Probiotic | 0.10 | 0.10 | 0.10 | 0.10 | 0.10 | 0.10 | 0.10 |
| Lactose | 0.90 | 0.90 | 0.90 | 0.90 | 0.90 | 0.90 | 0.90 |
| Pluronic F- | 5.0 | 10.0 | 15.0 | 20.0 | 2.0 | 2.0 | 2.0 |
| 127 | | | | | | | |
| Lubricant | | | | | | | |
| Water | 56 | 80 | 55 | 60 | 16.9 | 22.2/31.6** | — |
| Absorption | | | | | | | |

*The sodium bentonite used was Boxiecat ® cat litter.
**The 5 second absorption test.

The Examples 30 to 36 were tableted as those of Table 1.

Pluronicpluronic® F-127, also known as poloxamer 407, is a non-toxic and nonionic copolymer. It contains polyethylene oxide-polypropylene oxide arranged in a triblock structure to form PEO-PPO-PEO. It is sold by BASF.

In Example 34, the sodium polyacryate was sieved with a 100 mesh screen.

TABLE 5
Examples 37 to 46

| Components | Ex 37 | Ex 38 | Ex 39 | Ex 40 | Ex 41 | Ex 42 | Ex 43 | Ex 44 | Ex 45 | Ex 46 | Ex 47 |
|---|---|---|---|---|---|---|---|---|---|---|---|
| Sodium | 84 | 74 | 64 | 84 | 84.0 | 84.0 | 96.0 | 96.0 | 96.0 | 98.0** | 91.0 |
| Bentonite | | | | | | | | | | | |
| (clay) | | | | | | | | | | | |
| Sodium | 3.0 | 3.0 | 3.0 | 3.0 | 3.0 | 3.0 | 1.0 | 1.0 | 1.0 | — | 1.0 |
| Polyacrylate | | | | | | | | | | | |
| (SAP) | | | | | | | | | | | |
| Probiotic | 0.10 | 0.10 | 0.10 | 0.10 | 0.10 | 0.10 | 0.10 | 0.10 | 0.10 | — | 0.10 |
| Lactose | 0.90 | 0.90 | 0.90 | 0.90 | 0.90 | 0.90 | 0.90 | 0.90 | 0.90 | — | 0.90 |
| Pluronic F- | 2.0 | 2.0 | 2.0 | 2.0 | 2.0 | 2.0 | — | — | — | — | — |
| 127 | | | | | | | | | | | |
| Lubricant | | | | | | | | | | | |
| Sterotex | — | — | — | — | — | — | 2.0 | 2.0 | 2.0 | 2.0 | 2.00 |
| HM | | | | | | | | | | | |
| (Lubricant) | | | | | | | | | | | |
| Carbopol | — | — | — | — | — | — | — | — | — | — | 5.00 |
| 971P | | | | | | | | | | | |
| gelling | | | | | | | | | | | |
| agent | | | | | | | | | | | |
| Corn Starch | 10 | 20 | 30 | 10.0* | 10.0 | 10.0 | — | — | — | — | — |
| Binder | | | | | | | | | | | |
| Water | 15.7 | 19.4 | — | 18.7 | — | — | — | 13.3 | 21.85 | 25.50 | — |
| Absorption | | | | | | | | | | | |

*pre-gel corn starch
**Boxiecat litter screened through a 20 mesh screen.

Carbopol 971P, sold by Lubrizol, is a crosslinked polyacrylic polymer that provides a three dimensional gel structure gelling agent. Example 45 was dry mixed together and passed through a #40 sieve before tableting. Example 47 was tableted into a 0.1181×0.1969 inch rectangle.

The corn starch binder was difficult to blend into the other materials, and tended to gum-up the tablet die and punch.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A cat litter comprising at least one solid water-absorbent material and at least one tableted clay, wherein the at least one tableted clay table consists of from 50.0 to 99.9 wt. % clay, from 0.1 to 10 wt. % lubricant, from 0 to 10 wt. % disintegrating agent, from 0 to 10.0 wt. % super absorbent polymer, and from 0 to 10 wt. % beneficial additive.

2. The cat litter of claim 1, wherein the beneficial additive is at least one probiotic in the range of 0.01 to 5.0 wt. % of the tablet.

3. The cat litter of claim 2, wherein the clay is sodium bentonite clay.

4. The cat litter of claim 3, wherein the solid water-absorbent material is selected from the group consisting of clays, silica gels, woods, agricultural products, pumice, absorbent foamed materials, and combinations thereof.

5. The cat litter of claim 4, wherein the water-absorbent material is granulated clay.

6. The cat litter of claim 5, wherein the granulated clay is sodium bentonite.

7. A cat litter comprising at least one solid water-absorbent material and at least one tableted clay, wherein the at least one tableted clay table consists of from 70.0 to 99.9 wt. % clay, from 0.1 to 5 wt. % lubricant, from 0.1 to 10 wt. % disintegrating agent, from 0.1 to 10.0 wt. % super absorbent polymer, and from 0.01 to 10 wt. % beneficial additive.

8. The cat litter of claim 7, wherein the at least one tableted clay contains from 0 to 5.0 wt. % binder.

9. The cat litter of claim 8, wherein the at least one tableted clay contains from 0 to 2.0 wt. % binder.

10. The cat litter of claim 9, wherein the at least one tableted clay absorbs 10 wt. % or more of water when immersed in water for from 1 to 5 seconds.

11. A cat litter comprising at least one solid water-absorbent material and at least one tableted clay, wherein the at least one tableted clay table consists of from 70.0 to 99.9 wt. % clay, from 0.1 to 5 wt. % lubricant, from 0.1 to 10 wt. % disintegrating agent, from 0.1 to 10.0 wt. % super absorbent polymer, and from 0.01 to 5.0 wt. % at least one probiotic.

12. The cat litter of claim 11, wherein the clay is sodium bentonite clay.

13. The cat litter of claim 12, wherein the solid water-absorbent material is selected from the group consisting of clays, silica gels, woods, agricultural products, pumice, absorbent foamed materials, and combinations thereof.

14. The cat litter of claim 13, wherein the water-absorbent material is granulated clay.

15. The cat litter of claim 14, wherein the granulated clay is sodium bentonite.

16. The cat litter of claim 15, wherein the at least one tableted clay contains from 0 to 5.0 wt. % binder.

17. The cat litter of claim 16, wherein the super absorbent polymer comprises sodium polyacrylate.

18. The cat litter of claim 16, wherein the at least one tableted clay contains from 0 to 2.0 wt. % binder.

19. The cat litter of claim 7, wherein the at least one tableted clay absorbs 10 wt. % or more of water when immersed in water for from 1 to 5 seconds.

20. The cat litter of claim 11, wherein the at least one tableted clay absorbs 10 wt. % or more of water when immersed in water for from 1 to 5 seconds.
